(19) United States
(12) Patent Application Publication
(10) Pub. No.: US 2017/0193867 A1
(43) Pub. Date: Jul. 6, 2017

(54) SOLAR SNOW GLOBE

(71) Applicants: Shigang Wei, Quanzhou (CN); Ziangbing Zhao, Quanzhou (CN); Coleman Cable, LLC, Waukegan, IL (US)

(72) Inventors: Shiao-Tsun Ku, Waukegan, IL (US); Shigang Wei, Quanzhou (CN); Xiangbing Zhao, Quanzhou (CN)

(21) Appl. No.: 15/266,584

(22) Filed: Sep. 15, 2016

(30) Foreign Application Priority Data
Dec. 31, 2015 (CN) 201521136348.X

(51) Int. Cl. G09F 19/02; H02S 99/00; H02S 40/38

(52) U.S. Cl. CPC G09F 19/02; H02S 40/38; H02S 99/00

(57) ABSTRACT

A solar snow globe utilizing a pair of magnets to drive an impeller within the enclosed area of the snow globe. Particularly, a controller intermittently operates a motor when an ambient light detector senses darkness (e.g., at night), thereby creating a unique visual effect of a snowstorm blowing circumferentially within the enclosed area of the globe.

### RELATED APPLICATION

This application claims the benefit of Chinese patent application serial No. 201521136348.X, filed Dec. 31, 2015, the entirety of which is hereby incorporated by reference.

### FIELD OF THE INVENTION

This invention relates generally to display devices, more particularly to snow globes, and still more particularly to solar snow globes that create a unique visual effect.

### BACKGROUND OF THE INVENTION

Snow globes have been around for many years. The standard snow globe typically includes a three dimensional scene (e.g., skyline or figure) within an enclosed transparent globe or enclosure that is filled with particles suspended in a liquid. While at rest, the particles fall to the bottom of the enclosure. Picking up the snow globe and shaking it causes the particles to be spread out in the liquid within the enclosure. When placed back down on the surface, the snow globe gives the impression of falling snow as the particles fall back down to the bottom. While these globes provide a visual effect, such an effect is only temporary and only replicates snow falling downward. Recently, it has been known to include a continuous rotating member within the globe to create a visual effect of an object spinning inside.

BRIEF SUMMARY OF THE INVENTION

The present invention comprises a display device that utilizes a computerized control of a motor to create the effect of particles (e.g., simulated snow) traveling substantially circumferentially around the enclosed area of the device to create a circular snowing effect. In one embodiment, the display device is a solar snow globe that includes a transparent globe that rests in a base that is positionable above ground through the use of a stake. The globe may include a neck extending downward for facilitating placement and engagement with the base and for providing an opening for placement or location of a plug or seal that retains a liquid therein. A plurality of particles are immersed in the liquid to create a visual effect when agitated by an impeller located within the enclosed area of the globe.

An impeller is connected to a first magnet that is positioned to move relative to a corresponding second magnet on the other side of the plug or seal. A controller intermittently activates a motor to rotate the second magnet, which in turn rotates the first magnet and impeller. The solar snow globe may include an ambient light detector that permits the solar receiver to charge the battery during the daytime and activate the motor and a light when the ambient light detector detects a certain level of darkness (e.g., at night). Once activated, the intermittent operation of the motor creates a unique visual effect of particles (or snow) traveling in a substantially circumferential direction around the globe.

Accordingly, it is an object of the present invention to provide a solar display device that is economical and easy to manufacture and use.

It is another object of the present invention to provide a solar display device that creates a unique visual effect.

Other objects, features and advantages of the invention will be apparent from the following detailed disclosure, taken in conjunction with the accompanying sheets of drawings, wherein like reference numerals refer to like parts.

### BRIEF DESCRIPTION OF THE DRAWINGS

FIG. 1 is a perspective view of one embodiment of the solar display device of the present invention.

FIG. 2 is a cross sectional view of the solar display device of FIG. 1 taken along line 3-3.

FIG. 3 is a partial exploded view of the base and globe of the solar display device of FIG. 1.

FIG. 4 is a perspective view of the impeller of the solar display device of FIG. 1.

FIG. 5 is a schematic diagram of the power supply of the solar display device of FIG. 1.

FIG. 6 is a schematic diagram of the controller of the solar display device of FIG. 1.

### DETAILED DESCRIPTION OF THE INVENTION

While this invention is susceptible of embodiment in many different forms, there is shown in the drawings and will herein be described in detail several specific embodiments, with the understanding that the present disclosure is to be considered merely an exemplification of the principles of the invention and the application is limited only to the appended claims.

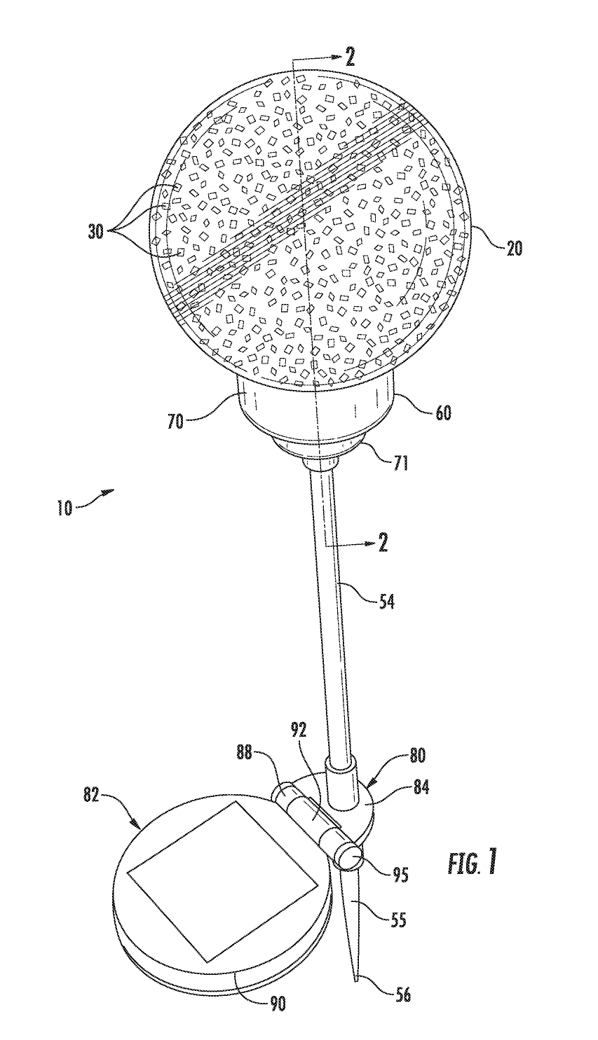

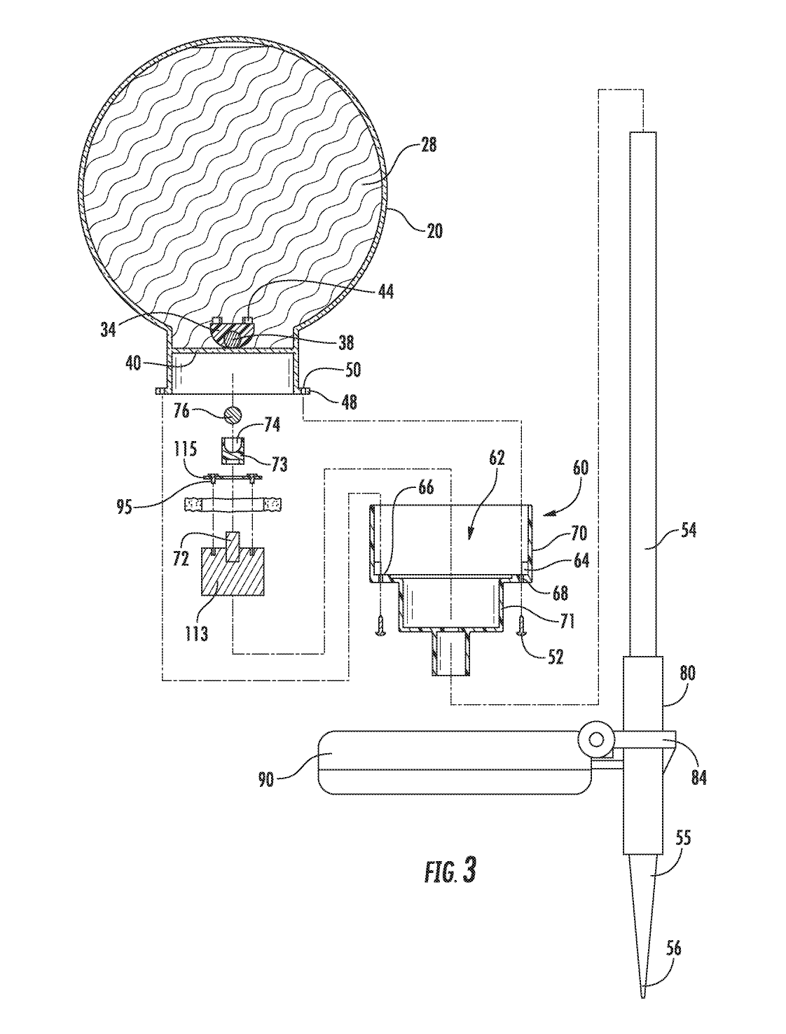

FIGS. 1 through 3 show one embodiment of the solar display device 10 of the present invention. The display device includes a shell or globe 20 secured within a base 60 that is connected to a stake 54 to allow the globe 20 to be positioned a distance above ground.

The globe 20 includes a spherical housing 22 having a neck 24 extending downwardly from the bottom of the globe 20. While the globe may be made of a transparent rubber material to allow particles to be seen therein and to protect the globe from breaking, it is appreciated that other transparent or translucent materials (to the extent that they permit the visual effects within the globe to be seen) may be used including, but not limited to glass, plastics and other polymer materials.

The spherical housing 22 defines an enclosed area 26 for retaining a plurality of particles 30 immersed within a liquid 28. The particles 30 are preferably small in size and may be a variety of shapes includes rectangular. In order to reflect light exposed to their surface during use, the particles may be made of a reflective material. Once the spherical housing 22 is filled with the liquid 28 and particles 30, the impeller 32 is also placed within the enclosed area 26.

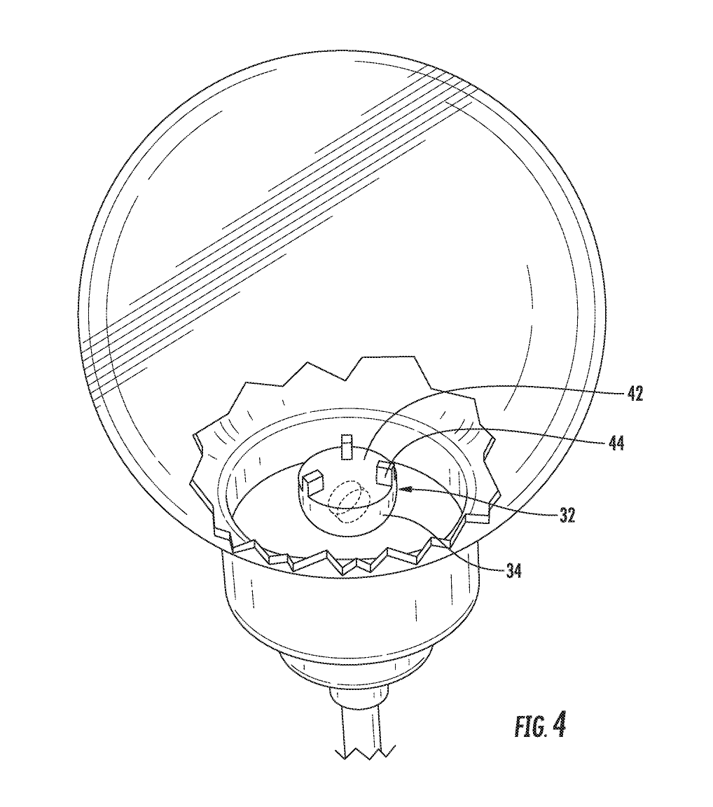

Referring to FIG. 4, the impeller 32 may consist of a housing 34 that includes an area 36 for receiving or otherwise enveloping a magnet 38 therein. The housing 34 is preferably made from a material that will withstand being submerged in the liquid 38 and which has a lower coefficient of friction to facilitate the rotation of the impeller 32 against the surface of the seal or plug 40. The top 42 of the housing 34 includes a plurality of vanes 44 or members extending upwardly to agitate the liquid 28 and particles 30 when in use. While a variety of number of vanes 44 may be used, the embodiment shown in FIG. 4 shows three vanes 44 equally spaced apart from one another on the top 42 of the impeller housing 34.

The spherical housing 22 is then sealed with a closure member to prevent the liquid 28 from escaping from therein during use. It is appreciated that the closure member may be a selectively removable member such as, but not limited to, a rubber plug or stopper or a permanent member if it is not desired to access the contents of the globe 20. The embodiment shown in the drawings illustrates a permanent closure member in the form of a rubber wall or plug that is transparent to permit light to pass therethrough.

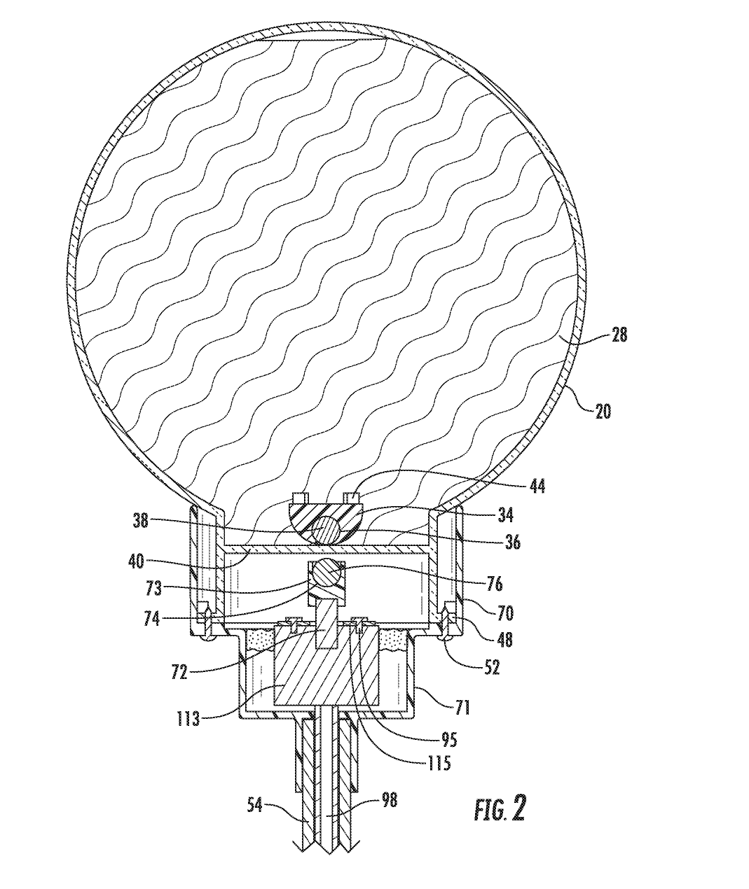

The bottom of the neck 24 may include a pair of flanges 48 extending outwardly therefrom. Referring to FIG. 2, the flanges 48 have threaded openings 50 extending therethrough for receiving screws or other threaded fasteners 52 that extend through corresponding holes 68 within the base 60. It is appreciated that the flanges may also be part of an annular ring or other member that is affixed to the bottom of the neck. It is also appreciated that the neck may include external threads for mating with corresponding internal threads on the interior of the base

The base 60 for the globe 20 includes an inner cavity 62 that is sized to receive the neck 24 of the globe 20. Referring to FIG. 4, the base 60 may be cylindrical in shape. A rib 64 on the bottom 66 of the upper portion 70 of the base 60 may be utilized as a stop for the bottom of the neck 24 to provide an annular contact and to protect the internal components located in the base 60. A pair of holes 68 may extend therethrough and be positioned to align with the holes 50 in flanges 48 to permit fasteners 52 to be inserted to connect the base 60 to the globe 20. A lower portion 71 of the base 60 may be utilized to house the motor 113. Rotor 72 extends through the middle of the motor 113 and includes an end member 73 that defines a pocket 74 for receiving a magnet 76. The end member may be made out of a variety of materials including, but not limited to rubber. Controller 115 may be positioned within the base 60 (e.g., attached to motor 113 as shown in the figures) and be operational connected to the battery 94 (e.g., through screws or fasteners 95), the light 112 and the motor 113 through wires or other known means. The controller 115 includes a light module comprising microcontroller 106, transistor 111 and LED 112 that activates the light and a motor module comprising microconroller 106, transistor 111 and motor 113 that intermittently activates the motor 113 when the ambient light detector detects a certain level of darkness. While the base is shown as a two-tiered cylindrical unit, it is appreciated that the base may be of a variety of shapes and sizes and not depart from the scope of the present invention.

Referring to FIG. 2, the stake may consist of a number of sections 54, 55 that matingly connect to one another and to the base 60 to position the globe 20 a particular distance above the ground. It is appreciated that the stake may be made out of a variety of materials including, but not limited to, metals such as steel, plastics or rubber. The end of the stake 55 may include a spike or tapered end 56 to facilitate insertion of the stake 55 into the ground.

A connector 80 may be utilized to attach multiple sections of the stake 54, 55 together, as well as to connect the solar receiver 82 to the stake 54. One embodiment of a connector 80 is shown in FIGS. 1 and 2 having a tubular frame 84 that is sized for receiving ends of respective stake members 54, 55 therein. A base 86 extends outwardly from about the tubular frame 84 and includes a pair of spaced-apart cylindrical hinge members 88 for rotatably receiving the housing 90 for the solar receiver 82. In particular, the housing 90 for the photovoltaic cell or solar receiver 92 may include a tubular connecting member 92 on its end that fits within the pair of hinge members such that a cylindrical member 95 may extend therethrough to permit the photovoltaic cell housing 90 to be selectively rotated for storage or to facilitate reception of light rays to generate power. While a solar snow globe being positioned on a stake is shown and disclosed, it is appreciated that other solar display devices may be used with or without a stake and not depart from the scope of the present invention.

The solar receiver 82 is positioned on the top of the housing 90 for receiving light during the day, which can then be converted into energy to charge a rechargeable battery (not shown) to provide power to the light and motor 113 during use. An ambient light detector may be used to allow the battery to charge during the day and provide illumination and the visual effects when it detects a certain level of darkness (e.g., at night). A diode within the solar controller 103 may be used to prevent the battery from dispersing power to the light and/or motor 113 while the solar receiver 82 is still receiving adequate light.

The tubular frame 84 may include an opening to permit wires 98 to extend from the housing 90 into the stake members 54, 55 to operatively connect to the motor 113 and light 112 to selectively provide power thereto.

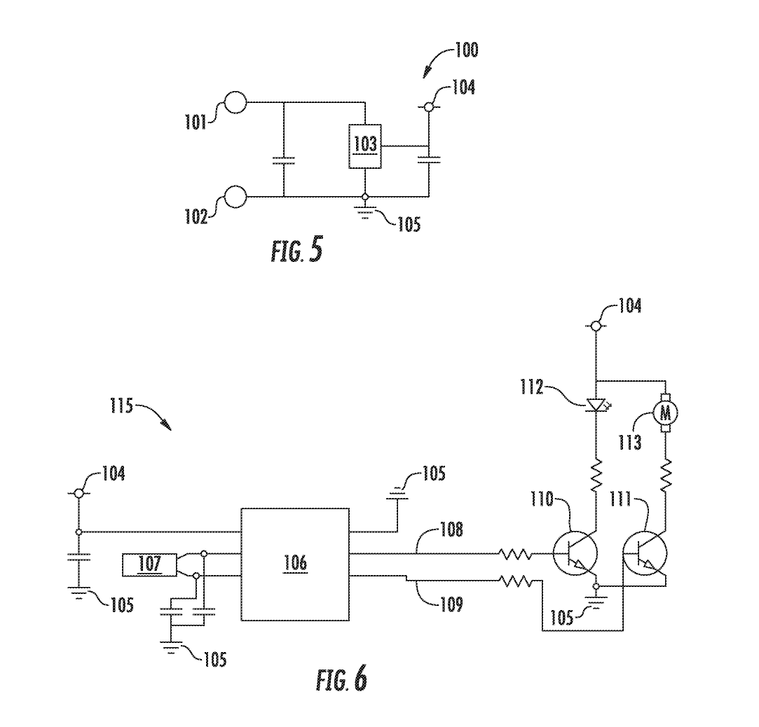

Referring to FIG. 5, a power supply 100, suitable for use in conjunction with the present solar display device, is shown as comprising solar panel terminals 101, 102 and solar power controller 103. Solar panel terminals 101, 102 are coupled to the outputs of a suitable photovoltaic cell or solar receiver 92. When power is received at terminals 101, 102, solar power controller 103 causes a battery, forming a part of the solar power controller, to be charged. Solar power controller 103 further includes an ambient light detector, which uses the power received at terminals 101 and 102 as an indicator as to whether the solar panel is presently in daylight or darkness conditions. When darkness is detected and the battery of solar power controller 103 is sufficiently charged, solar power controller 103 causes a predetermined direct current voltage, such as 2.8 volts, to be continuously output at Vcc terminal 104, relative to ground reference terminal Gnd 105.

Referring to FIG. 6, a controller 115 suitable for controlling the present solar display device 10 is shown as comprising microcontroller 106, oscillator 107, LED control output signal 108, motor control output signal 109, LED control transistor 110, motor control transistor 111, Light Emitting Diode (LED) 112, and direct current (DC) motor 113. Microcontroller 106 may comprise, for example, a general purpose, 8-bit, one-time programmable, RISC-type microcontroller designed for multiple I/O product applications, such as, for example, the HT58R05 microcontroller manufactured by Holtek Semiconductor, Inc. of Hsinchu, Taiwan. As shown in FIG. 6, two dedicated pins of microcontroller 106 are coupled to the Vcc 104 and Gnd 105 terminals output from power supply 100 in order to power the microcontroller. Crystal oscillator 107, in conjunction with two load capacitors, is coupled to two dedicated input pins of microcontroller 106 in order to provide a desired timebase for the microcontroller, such as, for example, a 4 Mhz instruction clock cycle operation.

The prestored programming within microcontroller 106 causes the microcontroller, when powered, to periodically switch motor 113 on and off to, in turn, cause the impeller 32 and its associated magnet 38 to periodically switch between rotating and idle modes of operation. In particular, a digital signal output by pin 109 of microcontroller 106 switches the base of transistor 111 on and off. This, in turn, causes current to periodically flow, and cease from flowing, through motor 113. In one embodiment of the invention, motor 113 is repeatedly switched on for fifteen seconds followed by fifteen seconds of unpowered, idle operation via by switching pin 109 on and off in such fashion. For certain types of motors, a pulse width modulated voltage, rather than a constantly on voltage, may be necessary or desirable whenever the motor is to be operated. In such circumstances, microcontroller 106 causes pin 109 to cycle in pulse width modulated fashion.

The operation of LED 112 is likewise under the control of microcontroller 106 and its associated, prestored programming. By controlling the digital signal output by pin 108 of the microcontroller, microcontroller 106 switches the base of transistor 110 to, in turn, control the flow of current through LED 112, in order to switch LED 112 on and off under programmed control. In one embodiment of the invention, LED 112 is illuminated continuously, whenever power is available to microcontroller 106 (i.e., whenever the present apparatus is in darkness and the battery is sufficiently charged). In another embodiment of the invention, LED 112 is switched on and off contemporaneously with the on/off operation of motor 113.

In operation, solar receiver 82 receives light from the sun during the day and converts the light to energy that is stored in a battery. When the ambient light detector detects a certain darkness level, the diode allows power to be supplied to the controller for activating the light 112 to illuminate the snow globe and the motor 113 to rotate the rotor 72. Rotation of the first magnet 76 on the end 73 of the rotor 72 causes the second magnet 38 within the housing 34 of the impeller 32, and thus the impeller 32 itself, to rotate. Rotation of the impeller 32 agitates the liquid 28 therein and causes the particles 30 to move therein. In particular, when activated, the impeller 32 moves the liquid 28 in such a way to generally move the particles 30 upward and rotationally within the globe 20. After a short period of time (e.g., 15 seconds), the controller 115 cuts off power to the motor 113, which stops rotation of the impeller 32. Cessation of the rotation of the motor 113 causes the particles 30 to slow down and move substantially circumferentially within the globe 20 to create a circular snow effect. After a short period of time (e.g., 15 seconds), the controller 115 reactivates the motor 113, which causes the particles 20 to again be urged upwardly and rotationally within the globe 20. The cycle continues to repeat while the power is permitted to flow to the controller 115 (e.g., at night or when the ambient light detector detects a certain level of darkness).

It will be understood that modifications and variations may be effected without departing from the spirit and scope of the present invention. It will be appreciated that the present disclosure is intended as an exemplification of the invention and is not intended to limit the invention to the specific embodiment illustrated and described. The disclosure is intended to cover, by the appended claims, all such modifications as fall within the scope of the claims.

1. A solar display device comprising:
a shell having a bottom, an interior that defines an enclosed area and a neck extending from bottom of the shell;
a liquid having a plurality of small particles immersed therein within the enclosed area; and
a closure member located within the neck and creating a watertight seal therein;
an impeller located within the enclosed area;
a first magnet connected to the impeller;
a solar receiver for converting light into energy;
a rechargeable battery for storing the energy;
an ambient light detector for permitting energy to flow from the battery only upon the environment of the solar display device having a certain level of darkness;
a base having an interior cavity sized to receive at least a portion of the neck, the base comprising:
a light source for projecting light into the enclosed area;
a motor;
a rotor operatively attached to the motor;
a second magnet operatively attached to the rotor;
a controller for activating the light and for intermittently operating the motor when the ambient light detector permits energy to flow from the battery, the intermittent operation of the motor creating the visual effect of the particles moving in a substantially circumferential direction within the enclosed area in the period of time when the motor is turned off and before it is turned on again.

2. The solar display device of claim 1 wherein the solar display device is a solar snow globe.

3. The solar display device of claim 1 which further comprises a stake for attaching to the base.

4. The solar display device of claim 1 wherein the light source is an LED.

5. The solar display device of claim 1 wherein the closure member is permanent.

6. The solar display device of claim 1 wherein the closure member is removable.

7. The solar display device of claim 6 wherein the closure member is a plug.

8. The solar display device of claim 1 wherein the shell is transparent.

9. The solar display device of claim 1 wherein the closure member is transparent.

10. The solar display device of claim 1 which further comprises an impeller housing that is not physically attached in place within the enclosed area.

11. A solar snow globe comprising:
a transparent shell having a bottom, an interior that defines an enclosed area and a neck extending from bottom of the shell;
a liquid having a plurality of small particles immersed therein within the enclosed area; and
a closure member located within the neck and creating a watertight seal therein;
an impeller located within the enclosed area;
a first magnet connected to the impeller;
a solar receiver for converting light into energy;
a rechargeable battery for storing the energy;
an ambient light detector for permitting energy to flow from the battery only upon the environment of the solar display device having a certain level of darkness;
a base having an interior cavity sized to receive at least a portion of the neck, the base comprising:
a light source for projecting light into the enclosed area;
a motor;
a rotor operatively attached to the motor;
a second magnet operatively attached to the rotor;
a controller for activating the light and for intermittently operating the motor when the ambient light detector permits energy to flow from the battery, the intermittent operation of the motor creating the visual effect of the particles moving in a substantially circumferential direction within the enclosed area in the period of time when the motor is turned off and before it is turned on again; and
a stake connected to the base.

12. The solar snow globe of claim 11 wherein the stake further comprises a spike.

13. The solar snow globe of claim 11 wherein the light source is an LED.

14. The solar snow globe of claim 11 wherein the closure member is permanent.

15. The solar snow globe of claim 11 wherein the closure member is removable.

16. The solar snow globe of claim 15 wherein the closure member is a plug.

17. The solar snow globe of claim 11 wherein the closure member is transparent.

18. The solar snow globe of claim 11 which further comprises an impeller housing that is not physically attached in place within the enclosed area.
